(19) United States
(12) Patent Application Publication
(10) Pub. No.: US 2012/0213462 A1
(43) Pub. Date: Aug. 23, 2012

(54) NEEDLE ROLLER BEARING FOR A BEARING ARRANGEMENT

(75) Inventors: Peter FRIEDRICH, AUERNHEIM (DE); Michael KRUEGER, SCHWEINFURT (DE); Reinhart MALIK, HERZOGENAURACH (DE); Steffen SAEBSCH, WEISENDORF (DE); Heinz SCHAEFERS, ERLANGEN (DE); Matthias FICK, SCHNAITTACH (DE); Manfred WINKLER, AURACHTAL (DE); Johannes ENDERS, HERZOGENAURACH (DE)

(73) Assignee: SCHAEFFLER TECHNOLOGIES AG & CO. KG, Herzogenaurach (DE)

(21) Appl. No.: 13/399,078

(22) Filed: Feb. 17, 2012

(30) Foreign Application Priority Data
Feb. 17, 2011 (DE) 10 2011 004 336.5

(51) Int. Cl. F16C 33/58

(52) U.S. Cl. 384/564; 384/571

(57) ABSTRACT

A needle roller bearing for a bearing arrangement, which has cage-guided cylindrical needle rollers arranged between and in rolling contact with a conical outer raceway and a conical inner raceway. For manufacturing, for economic purposes, and to keep the dimensions of the needle roller bearing as small as possible, at least one of the two conical raceways is part of a thin-walled bearing bushing that is made without chip removal and has an outer cylindrical fitting surface for an interference fit in a housing.

### CROSS-REFERENCE TO RELATED APPLICATIONS

This application claims priority of DE 10 2011 004 336.5 filed Feb. 17, 2011, which is incorporated by reference herein.

### FIELD OF THE INVENTION

The invention relates to a needle roller bearing for a bearing arrangement, which has cage-guided cylindrical needle rollers arranged between and in rolling contact with a conical outer raceway and a conical inner raceway.

### BACKGROUND OF THE INVENTION

A needle roller bearing is described and illustrated in DE 21. 30 953 A1. This needle roller bearing comprises a solid outer ring, which has a conical raceway and a corresponding solid inner ring, which has an inner conical raceway that is parallel to the outer raceway. Cage-guided cylindrical needle rollers are arranged between and in rolling contact with the outer and inner raceways. This needle roller bearing therefore comprises the same elements as a common taper roller bearing with the difference that the conical raceways are parallel to each other and the needle rollers are accordingly cylindrical in shape.

However, due to the solid configuration of the bearing rings, these prior art needle roller bearings are bulky and heavy which makes them relatively expensive to manufacture and oversized for many cases of use.

### SUMMARY OF THE INVENTION

With this background, it is the object of the invention to provide a needle roller bearing with conical raceways that is a simple. structure which is economical to manufacture.

The invention achieves the above object with a needle roller bearing for a bearing arrangement which comprises cage-guided cylindrical needle rollers arranged between and in rolling contact with a conical outer raceway and a conical inner raceway. At least one of the two conical raceways is part of a thin-walled bearing bushing that is made without chip removal and comprises an outer or an inner cylindrical fitting surface for an interference fit on a shaft or in a housing.

Such a needle roller bearing can be manufactured economically because the bearing bushing together with a conical raceway can be made thin-walled and without chip removal. Such a bearing can be used particularly in cases of use in which needle roller bearings with solid bearing rings are oversized. Further, possible fields of use are bearings with a large bearing spacing and slantingly positioned shafts. Also to be mentioned are cases of use in transmissions and in universal joint bushings. Moreover, such bearings permit adjustment of a shaft tilt or of a required axial thrust.

If only one of the two conical raceways is part of a thin-walled bearing bushing made without chip removal, the other of the two conical raceways can be part of the shaft or the housing so that the needle rollers are in roiling contact, on one side, in or on the bearing bushing, and on the other side, on or in a corresponding conical raceway on the shaft or in the housing.

It is also possible for each of the two conical raceways to be part of a respective thin-walled bearing bushing made without chip removal, so that one of the bearing bushings with its outer cylindrical fitting surface can be arranged in the housing and the other bearing bushing with its inner cylindrical fitting surface can be arranged in an interference fit on the shaft.

If the at least one thin-walled bearing bushing made without chip removal is arranged with an outer cylindrical fitting surface on one end of the shaft in a housing, the bearing arrangement can be closed in a simple manner with a cover formed integrally on the bearing bushing, and the bearing bushing, which is closed on one side then comprises the outer conical raceway.

The needle roller bearing can be configured as a pre-assembled unit such that the cage-guided needle rollers are pushed into the bearing bushing or onto the bearing bushing and, subsequently, a turned-over edge for retaining and guiding the cage is formed without chip removal on one or on both ends of the bearing bushing. In the case of a bearing bushing closed on one side, only one turned-over edge is required. If the bearing bushing is open on both sides, turned-over edges must he provided on both ends of the bearing bushing.

### BRIEF DESCRIPTION OF THE DRAWING

The bearing bushing configured according to the invention will be described more closely in the following in three embodiments with reference to the appended drawings.

FIG. 1 shows a needle roller bearing of the invention for a hearing arrangement comprising a bearing hushing arranged in a housing;

FIG. 2 shows a needle roller bearing of the invention for a bearing arrangement comprising a bearing hushing arranged on a shaft; and

FIG. 3 shows a needle roller bearing of the invention for a bearing arrangement comprising a bearing hushing closed on one side with a cover.

### DETAILED DESCRIPTION OF THE INVENTION

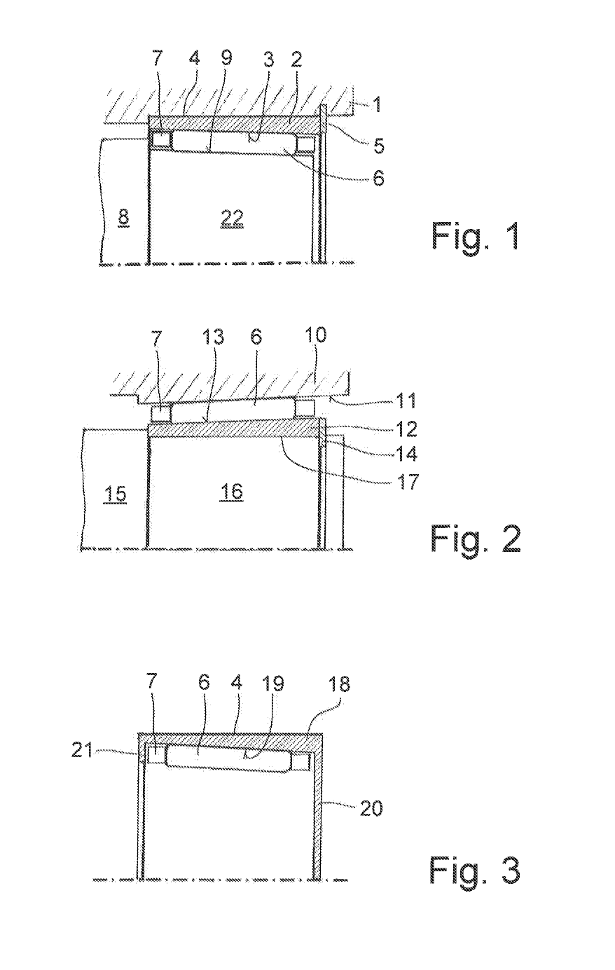

As can be seen in FIG. 1, an outer bearing bushing 2 is inserted for an interference fit into a bore of a housing 1 with help of a cylindrical outer fitting surface 4 and is additionally secured in axial direction through a locking ring 5. If the taper ratio of the raceways is insignificant and the resulting axial forces are comparatively low, the locking ring 5 can be dispensed with. The outer bearing bushing 2 comprises a conical outer raceway 3 extending parallel to a conical, inner raceway 9 of a conical, stepped shaft end 22 of a shaft 8. Between the two parallel, conical raceways 3, 9 are arranged needle rollers 6 that are guided in a cage 7 and are thus in rolling contact, on one side, with the conical, outer raceway 3 of the outer bearing bushing 2 and, on the other side, with the conical, inner raceway 9 of the conical stepped shaft end 22. In a known manner, the outer bearing bushing 2 is thin-walled and made. out of a sheet material without chip removal by a shaping method. The conical inner raceway 9 on the stepped shaft end 22 must possess an appropriate hardness for the respective case of use and this condition is normally fulfilled if the shaft 8 is made of an appropriate steel alloy.

The needle rollers 6 of the needle roller bearing illustrated in FIG. 2, are in direct rolling contact with a conical outer raceway 11 in a housing 10 and with a conical inner raceway 13 of an inner bearing hushing 12 while being likewise guided by a cage 7. The inner bearing bushing 12 in this case is pressed with its cylindrical fitting surface 17 onto a stepped, cylindrical shaft end 16 of a shaft 15 while being retained in axial direction on the stepped shaft end 16 by a locking ring 14.

The bearing bushing 18 illustrated in FIG. 3 is closed on one end with a cover 20 that is made without chip removal in one piece with the outer hearing hushing 18. Together with the needle rollers 6 guided in the cage 7, this bearing hushing 18 forms a pre-assembled structural unit in that, after the insertion of the needle rollers 6 guided in the cage 7, a turned-over edge 21 is formed on a cover-distal end of the bearing bushing 18. This pre-assembled structural unit can be inserted, for instance, as shown in FIG. 1, into a housing 1, and secured in the housing by the shown locking ring 5 so that the needle roller bearing is completely closed on the outside within the housing 1.

It is also possible to combine the forms of embodiment according to FIGS. 1, 2 and 3 in that, an outer bearing bushing 2 or 18 is inserted into the housing 1, and an inner bearing bushing 12 according to FIG. 2 is pressed onto a cylindrical, stepped shaft end 16.

It is further possible to provide on the outer bearing bushing 2 according to FIG. 1 and/or on the inner bearing bushing 12 according to FIG. 2, turned-over edges on both bearing bushing ends in order to axially retain and guide the needle rollers 6 guided in the cage 7 so that, in the case of these forms of embodiment as well, pre-manufactured structural units can be realized.

The constructional principle defined by the invention is also used if the taper ratio of the raceways is mirror-inverted with respect to the raceways shown in FIGS. 1 to 3.

### LIST OF REFERENCE NUMERALS

1 Housing
2 Outer Bearing Bushing
3 Conical Outer Raceway
4 Cylindrical Fitting Surface
5 Locking Ring
6 Needle Rollers
7 Cage
8 Shaft
9 Conical Inner Raceway
10 Housing
11 Conical Outer Raceway
12 Inner Bearing Bushing
13 Conical Inner Raceway
14 Locking Ring
15 Shaft
16 Stepped, Cylindrical Shaft End
17 Cylindrical Fitting Surface
18 Outer Bearing Bushing
19 Conical Outer Raceway
20 Cover
21 Turned-Over Edge
22 Stepped, Conical Shaft End

What is claimed:

1. A needle roller bearing for a bearing arrangement, comprising:
a conical outer raceway;
a conical inner raceway;
a cage;
cylindrical needle rollers, which are guided by the cage and arranged between and in rolling contact with the conical outer raceway and the conical inner raceway; and
a thin-walled bearing bushing which is made without chip removal and comprises an outer cylindrical fitting surface or an inner cylindrical fitting surface for an interference fit on a shaft or in a housing,
wherein at least one of the conical raceways is formed on the thin-walled bearing bushing.

2. The needle roller bearing according to claim 1, wherein both of the conical raceways are formed on the thin-walled bearing bushing that is made without chip removal.

3. The needle roller bearing according to claim 1, wherein one of the conical raceways is formed on the thin-walled bearing bushing that is made without chip removal and the other of the conical raceways is formed on of the shaft or the housing.

4. The needle roller bearing according to claim 1, wherein the thin-walled bearing bushing made without chip removal has an integrally formed cover that closes the thin-walled bearing bushing on the one side.

5. The needle roller bearing according to claim 4, wherein the outer conical raceway is formed on the thin-walled bearing bushing.

23. The needle roller bearing according to claim 1, wherein the thin-walled bearing bushing has a turned-over edge for retaining and guiding the cage, the turned-over edge being is formed without chip removal on at least one end of the thin-walled bearing bushing.
